(19) United States
(12) Patent Application Publication
(10) Pub. No.: US 2022/0316960 A1
(43) Pub. Date: Oct. 6, 2022

(54) PUCK FOR VISUALLY INDICATING THE TEMPERATURE OF A PET ENCLOSURE

(71) Applicant: dxImpact LLC, (US)

(72) Inventor: Jason Karamol, Waterville, OH (US)

(21) Appl. No.: 17/710,917

(22) Filed: Mar. 31, 2022

Related U.S. Application Data
(60) Provisional application No. 63/169,369, filed on Apr. 1, 2021.

(51) Int. Cl. G01K 11/12; A01K 1/03; B29C 64/118

(52) U.S. Cl. CPC G01K 11/12; A01K 1/03; B29C 64/118; B29L 2031/752

(57) ABSTRACT

Presented is a color-changing puck. The puck includes a body having an upper face such that the body, upon being subjected to a plurality of temperature ranges is configured to (i) emit a first predefined color from the upper face, when the body is subjected to a first temperature range of the plurality of temperature ranges, (ii) emit a second predefined color from the upper face when the body is subjected to a second temperature range of the plurality of temperature ranges, and (iii) emit a third predefined color from the upper face, when the body is subjected to a third temperature range of the plurality of temperature ranges. The puck is capable of visually indicating temperature inside the pet enclosure such that a person is able to easily and quickly monitor the temperature inside the pet enclosure in a continuous manner.

### CROSS-REFERENCE TO RELATED PATENT DOCUMENTS

This patent application claims the benefit of priority of U.S. Provisional Application No. 63/169,369, entitled “THE HEAT PUCK,” filed Apr. 1, 2021, which are hereby incorporated herein by reference in its entirety.

### TECHNICAL FIELD

The present invention generally relates to an object for indicating a temperature of a particular region. More particularly, the present invention relates to a puck that visually indicates the temperature of a pet enclosure.

### BACKGROUND

Many people keep reptiles as their pets. Pets require a proper space so that the pets can crawl (move) around a confined region. Pet owners usually opt for pet enclosures in which they can leave their pets.

The reptiles being cold-blooded in nature require a special kind of pet enclosure that can provide a sufficient temperature range for the pet to thrive in. The pet enclosures are available in various shapes and sizes depending on the requirement of the pet. The pet enclosures usually comprise a heat source, which when operated provide a comfortable temperature for the pets crawling inside the pet enclosure. Because the temperature within the pet enclosure must remain within a comfortable temperature range, there is a continuous requirement of monitoring the temperature inside the pet enclosure. Thus, the pet enclosures available come up with a variety of thermometers that are configured with the pet enclosures. These thermometers are capable of providing temperature values for the basking area of the pet enclosure.

For instance, U.S. Pat. No. 6,810,833B2 discloses display devices including a habitat for showcasing animals such as reptiles, amphibians, and other animals commonly sold in retail pet or specialty pet stores and controlling the environment of such habitat. The front wall of the tank may include an in-tank thermometer adhered to the inside surface of the front panel and visible through the window. As disclosed in U.S. Pat. No. 6,810,833, an animal caretaker can easily access and view the thermometer to take a reading of internal habitat temperature.

The major drawback associated with the use of the thermometer is that the temperature values must be noted down carefully in order to get temperature indications of the basking area of the pet enclosure. The pet owners must memorize the value of a comfortable temperature range for the basking area, which helps them to be aware of the comfort of their pets. Further, in order to get temperature values of the basking area of the pet enclosure, the pet owner must go closer to the pet enclosure and note down the thermometer readings. While noting down the thermometer readings there are abundant chances of noting down wrong temperature readings for the basking area of the pet enclosure due to various reasons such as but not limited to: human error, improper lighting conditions, fear from pets, and so on. The noting down of wrong temperature readings may delude the pet owner about the health of the pet residing inside the pet enclosure. Further, taking readings from a thermometer is a time-consuming process and requires some level of skill. Thus, it is very difficult to continuously monitor the temperatures inside the pet enclosure using a thermometer. For instance, if a pet owner takes consecutive thermometer readings after a long interval of time (i.e. 1 hour), it is possible due to various reasons such as but not limited to: malfunction in heating source, power supply cut off, and so on that the temperature inside the pet enclosure has drastically changed within that interval of time which could add to the discomfort of the pet inside the pet enclosure.

In light of the foregoing, there is a need for a device that is capable of indicating temperature for a particular region such that a person is able to easily and quickly monitor the temperature inside the pet enclosure in a continuous manner.

### SUMMARY

Before the present systems and methods, embodiments are described, it is to be understood that this application is not limited to the particular systems, and methodologies described, as there can be multiple possible embodiments that are not expressly illustrated in the present disclosures. It is also to be understood that the terminology used in the description is for the purpose of describing the particular versions or embodiments only, and is not intended to limit the scope of the present application.

It is an object of the present invention to provide a puck for a pet enclosure, the puck includes a body having an upper face such that the body, upon being subjected to a plurality of temperature ranges is configured to (i) emit a first predefined color from the upper face, when the body is subjected to a first temperature range of the plurality of temperature ranges, (ii) emit a second predefined color from the upper face when the body is subjected to a second temperature range of the plurality of temperature ranges, and (iii) emit a third predefined color from the upper face, when the body is subjected to a third temperature range of the plurality of temperature ranges.

In an embodiment, the body further includes a lower face and a lateral face such that the body, upon being subjected to the plurality of temperature ranges is configured to emit the first predefined color, the second predefined color and the third predefined color from the lower face and the lateral face.

In an embodiment, the first temperature range of the plurality of temperature ranges comprises the range of temperatures that are below from about 86° Fahrenheit (86° F.).

In an embodiment, the second temperature range of the plurality of temperature ranges comprises the range of temperature from about 86° F. to about 112° F.

In an embodiment, the third temperature range of the plurality of temperature ranges comprises the range of temperatures that are above from about 112° F.

In an embodiment, the puck is made up from a biodegradable material such as poly-lactic acid-based plastic.

In an embodiment the biodegradable material is amolen tri-color plastic material.

In an embodiment, the puck is made up of a single-piece thermoplastic material.

In another embodiment of the present invention, the puck is made up of a thermochromic material.

In an embodiment, the lower face of the body of the puck is configured to attach the puck inside the pet enclosure.

In an embodiment, the puck is made by fused deposition modelling (FDM) or injection molding.

In an aspect of the present invention, a pet enclosure is disclosed. The pet enclosure includes a plurality of walls that are configured to define an internal region, a heating source that is positioned in the internal region, and configured to generate heat in the internal region. The pet enclosure further includes a puck that is placed in the internal region, and configured to visually indicate temperature of the internal region by emitting one or more predefined colors.

Various objects, features, aspects and advantages of the present invention will become more apparent from the following detailed description of the embodiments of the invention, along with the accompanying drawings in which like numerals represent like components.

### BRIEF DESCRIPTION OF THE DRAWINGS

FIG. 1 illustrates a perspective view of a puck for a pet enclosure, according to an embodiment of the present invention;

FIG. 2 illustrates a side view of the puck of FIG. 1;

FIG. 3 illustrates a perspective view of a puck provided with an attachment member, according to another embodiment of the present invention; and

FIG. 4 illustrates a side view of the puck of FIG. 3;

FIG. 5 illustrates a perspective view of a pet enclosure comprising the puck of FIG. 3.

### DETAILED DESCRIPTION

Before describing the present invention in detail, it should be observed that the present invention utilizes a combination of components or processes, which constitutes a puck for a pet enclosure. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items.

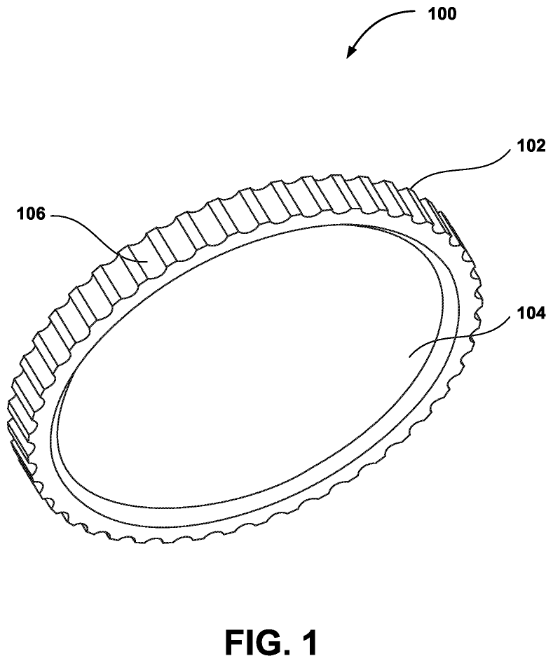

The heating puck will now be described with reference to the accompanying drawings, particularly FIGS. 1-5.

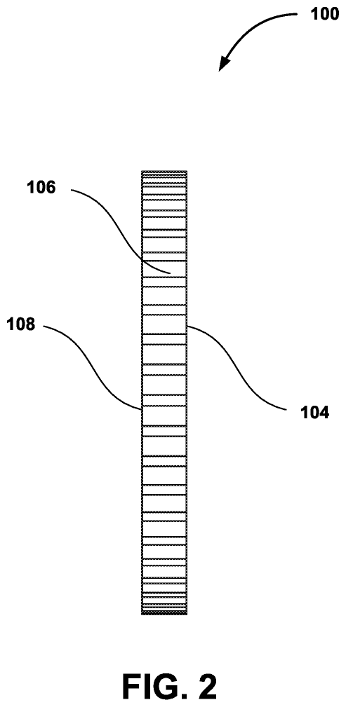

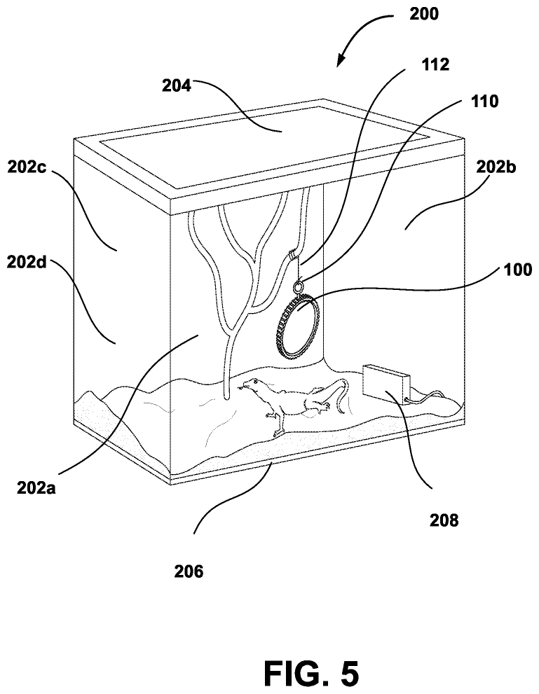

FIG. 1 and FIG. 2 depict a perspective view and a side view of a puck 100 for a pet enclosure 200 (as shown in FIG. 5) respectively. The puck 100 includes a body 102. The body 102 of the puck 100 includes an upper face 104, a lateral face 106 and a bottom face 108.

The puck 100 may be configured to visually indicate the temperature of a particular region by changing the color of the body 102 of the puck 100 in response to the temperature. The upper face 104 and the lateral face 106 of the body 102 may be configured to emit a plurality of predefined colors, upon being subjected to a plurality of temperature ranges. For example, the upper face 104 and the lateral face 106 may be configured to emit a first predefined color upon being subjected to a first temperature range of the plurality of temperature ranges. The upper face 104 and the lateral face 106 may be configured to emit a second predefined color upon being subjected to a second temperature range of the plurality of temperature ranges. The upper face 104 and the lateral face 106 may be configured to emit a third predefined color upon being subjected to a third temperature range of the plurality of temperature ranges.

In an exemplary embodiment, the first temperature range of the plurality of temperature ranges may be the range of temperatures that are below from about 86 degrees Fahrenheit (86° F.), the second temperature range of the plurality of temperature ranges may be the range of temperatures from about 86 degree Fahrenheit to about 112 degrees Fahrenheit, and the third temperature range of the plurality of temperature ranges may be the range of temperatures that are above from about 112 degrees Fahrenheit. The upper face 104 and the lateral face 106 of the body 102 may be configured to emit blue color upon being subjected to a range of temperatures that are below from about 86 degrees Fahrenheit. The upper face 104 and the lateral face 106 of the body 102 may be configured to emit green color upon being subjected to a range of temperatures from about 86 degrees Fahrenheit to about 112 degrees Fahrenheit. The upper face 104 and the lateral face 106 of the body 102 may be configured to emit yellow color, upon being subjected to the range of temperatures that are above from about 112 degrees Fahrenheit. However, it should be obvious to the one skilled in the art that the yellow, blue, and green colors described above are exemplary only and the upper face 104 and the lateral face 106 of the body 102 could also emit various other colors including but not limited to: red, orange, grey, pink, black, white and so on depending on the requirement of the pet owner.

In an embodiment, the material of the puck 100 may be a bio-degradable material such as polylactic-acid-based plastic. The polylactic-acid based plastic material may be amolen tri-color plastic material. In another embodiment, the material of the puck 100 may be a single-piece thermoplastic material. In another embodiment, the material of the puck 100 may be any kind of thermochromic material such as but not limited to titanium dioxide, zinc sulfide, zinc oxide, or the like. In yet another embodiment, the puck 100 may be manufactured by fusion deposition modelling (FDM) or injection molding manufacturing process.

In another embodiment, the bottom face 108 may be configured to emit the plurality of predefined colors upon being subjected to the plurality of predefined temperature ranges. For example, the bottom face 108 of the puck 100 may be configured to emit the same color as the upper face 104 and the lateral face 106, when the upper face 104, the lateral face 106, and/or the bottom face 108 is subjected to the plurality of temperature ranges.

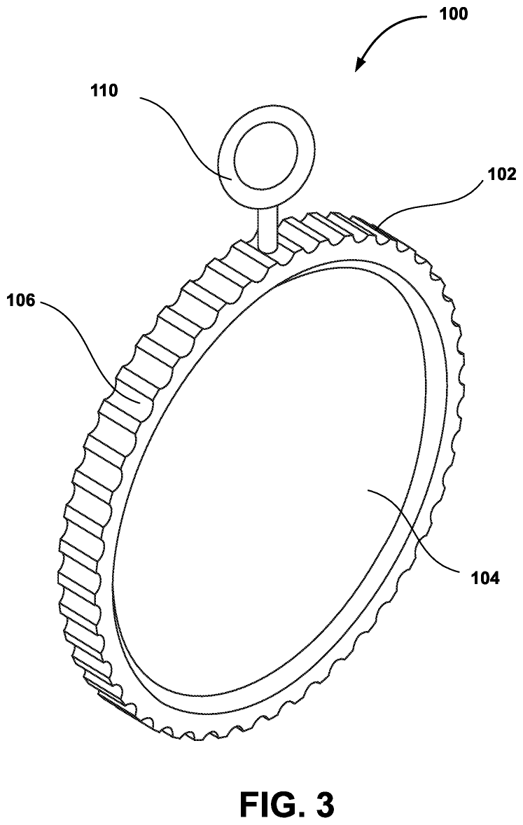

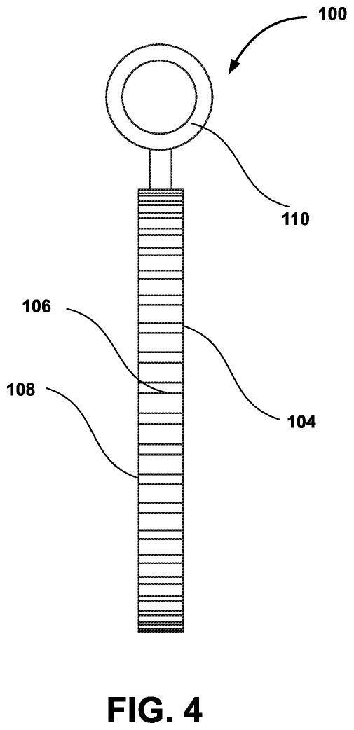

Referring now to FIG. 3 and FIG. 4, an attachment member 110 of the puck 100 is shown, according to another embodiment of the present invention. The attachment member 110 may extend from the lateral face 106 of the body 102 of the puck 100. The attachment member 110 may be configured to attach the puck 100 to any surface of the particular region. To place the puck 100 inside the pet enclosure, one end of a thread/cord 112 (FIG. 5) may be passed through the attachment member 110 such that the opposite end of the thread/cord 112 (FIG. 5) may be tied to a suitable place within the pet enclosure. The cable allows the puck 100 to be suspended inside the pet enclosure.

In another embodiment (not shown in figures), the puck 100 may be attached to the surface feature (not shown in the figure) of the particular region by engaging the attachment member 110 of the puck 100 with the surface feature (not shown in the figure) of the particular region. Once the attachment member 110 is engaged with the surface feature (not shown in the figure) of the particular region, the puck 100 will be laid over the surface of the particular region. The surface feature could include but are not limited to: bolt, pin, protrusion, male-female connector, and so on.

In another embodiment, the attachment member 110 may be a belt, a snap-lock, a Velcro-arrangement, male female connector, screw fastener, or the like.

In another embodiment, glue may be applied to the bottom face 108 of the body 102 of the puck 100 in order to attach the puck 100 to the surface of the particular region.

In another embodiment, a fastening element such as a bolt, stud, or rivet may pass through the body 102 of the puck 100 in order to attach the puck to the surface of the particular region.

In another embodiment, the attachment member 110 of the puck may extend from the bottom face 108 of the body of the puck 100.

FIG. 5 illustrates a perspective view of a pet enclosure 200. The pet enclosure 200 includes a plurality of walls 202a-202d, a lid 204, a base 206, and a heat source 208. The pet enclosure 200 comprises an internal region that may be defined by the plurality of walls 202a-202d, the lid 204, and the base 206 such that the internal region allows a reptile to move around, within the pet enclosure 200. The heat source 208 may be configured to generate heat for the reptiles that are enclosed inside the pet enclosure 200. The puck 100 may be positioned/placed in the internal region that is defined by the plurality of walls 202a-202d for visually indicating the temperature of the internal region by emitting one or more predefined colors (as described in detail hereinabove). To place the puck 100 inside the pet enclosure, one end of a thread/cord 112 may be passed through the attachment member 110 such that the opposite end of the of a thread/cord 112.

In another embodiment, the puck 100 may be attached to any surface of the internal region of the pet enclosure 200 such that the puck 100 may be configured to visually indicate the temperature of the internal region of the pet enclosure 200.

In another embodiment, the pet enclosure 200 may include a basking region such that the puck 100 may be attached to the basking region or near to the basking region. The basking region may be near the heat source 208 of the pet enclosure 200 which allows the reptiles to bask.

In another embodiment, a thermometer (not shown in the figures) may be used in conjunction with the puck 100 for enabling temperature indications for the particular region such as for the basking region of the pet enclosure 200. This configuration allows a pet owner to visually observe the puck 100 for monitoring temperature inside the pet enclosure as well as see temperature readings by using a thermometer (not shown in figures) for precision.

The various components, parts of the various embodiments of the puck 100 of the present invention are similar and interchangeable. It is obvious to the one skilled in the art that the various components, parts of the puck 100 of one embodiment of the present invention could be considered for other embodiments with little or no variation. Further, it should be understood that the similar pucks 100 with little or no variation could be used in applications other than pet enclosures involving a change in temperature. The other applications could include but are not limited to scientific laboratories, food plants, refrigerators, fish tanks, factories, and so on.

The puck 100 according to various embodiment as described above are configured to emit three colors depending on the temperature of the pet enclosure 200 in which the puck is placed. However, it is entirely possible that the number of colors that could be emitted by the puck 100 could be customized (changed) depending on the requirement of the pet owner. For instance, in an exemplary embodiment, the puck 100 could emit only two colors such that puck 100 is configured to emit a first predefined color upon being subjected to a temperature below a predetermined temperature and the puck 100 is configured to emit a second predefined color upon being subjected to a temperature equal or above then the predetermined temperature.

In another exemplary embodiment, the puck 100 could emit more than three colors such that the puck 100 is configured to emit a first predefined color upon being subjected to a first temperature range of the plurality of temperature ranges, the puck 100 is configured to emit a second predefined color upon being subjected to a second temperature range of the plurality of temperature ranges, the puck 100 is configured to emit a third predefined color upon being subjected to a third temperature range of the plurality of temperature ranges, the puck 100 is configured to emit a fourth predefined color upon being subjected to a fourth temperature range of the plurality of temperature ranges and so on. Broadly speaking, the puck 100 is configured to visually indicate the temperature of the internal region of the pet enclosure 200 by emitting at least two colors.

It should be understood according to the preceding description of the present invention that the same is susceptible to changes, modifications and adaptations, and that the said changes, modifications and adaptations fall within scope of the appended claims.

What is claimed is:

1. A puck (100) configured to be placed inside a pet enclosure (200), the puck (100) comprising:
a body (102), wherein that the body (102) upon being subjected to a plurality of temperature ranges is configured to:
(i) emit a first predefined color, when the body (102) is subjected to a first temperature range of the plurality of temperature ranges;
(ii) emit a second predefined color, when the body (102) is subjected to a second temperature range of the plurality of temperature ranges; and
(iii) emit a third predefined color, when the body (102) is subjected to a third temperature range of the plurality of temperature ranges.

2. The puck (100) of claim 1, wherein the body (102) comprises an upper face (104), a lateral face (106), and a lower face (108) and such that the body (102), upon being subjected to the plurality of temperature ranges is configured to emit the first predefined color, the second predefined color and the third predefined color from the upper face (104), the lateral face (106) and the lower face (108).

3. The puck (100) of claim 1, wherein the first temperature range of the plurality of temperature ranges comprises the range of temperatures that are below from about 86 degrees Fahrenheit (86° F.).

4. The puck (100) of claim 1, wherein the second temperature range of the plurality of temperature ranges comprises the range of temperature from about 86 degrees Fahrenheit to about 112 degrees Fahrenheit.

5. The puck (100) of claim 1, wherein the third temperature range of the plurality of temperature ranges comprises the range of temperatures that are above from about 112 degrees Fahrenheit.

6. The puck (100) of claim 1, wherein the puck (100) is made up of a biodegradable material.

7. The puck (100) of claim 6, wherein the biodegradable material comprises at least one of: amolen tri-color plastic material, poly-lactic acid-based plastic.

8. The puck (100) of claim 1, is made up of a single-piece thermoplastic material.

9. The puck (100) of claim 1, wherein the puck (100) is made up of a thermochromic material.

10. The puck (100) of claim 1, wherein an attachment member (110) is configured on the lateral face (106) of the puck (100) to enable holding the puck (100) inside the pet enclosure (200).

11. The puck (100) of claim 1, wherein the puck (100) is made by fused deposition modelling (FDM) or injection molding.

12. A pet enclosure (200) comprising:
a plurality of walls (202a-202d) that are configured to define an internal region;
a heat source (208) that is positioned in the internal region, and configured to generate heat in the internal region; and
a puck (100) placed in the internal region and configured to visually indicate the temperature of the internal region by emitting two or more predefined colors.

13. The pet enclosure (200) of claim 12, wherein the puck (100) comprises:
a body (102) having an upper face (104) such that the body (102), upon being subjected to a plurality of temperature ranges is configured to:
(i) emit a first predefined color from the upper face (104), when the body (102) is subjected to a first temperature range of the plurality of temperature ranges;
(ii) emit a second predefined color from the upper face (104), when the body (102) is subjected to a second temperature range of the plurality of temperature ranges; and
(iii) emit a third predefined color from the upper face (104), when the body (102) is subjected to a third temperature range of the plurality of temperature ranges.
